(19) United States
(12) Patent Application Publication
(10) Pub. No.: US 2025/0368669 A1
(43) Pub. Date: Dec. 4, 2025

(54) PHOSPHORUS-CONTAINING COMPOUND, MANUFACTURING METHOD THEREOF, FLAME-RETARDANT POLYPHENYLENE OXIDE RESIN COMPOSITION AND CURED PRODUCT

(71) Applicant: NATIONAL CHUNGHSING UNIVERSITY, Taichung City (TW)

(72) Inventors: Ching-Hsuan LIN, Taichung City (TW); Yi-Chun CHEN, Tainan City (TW); Tzu-Chin WEU, Taichung City (TW); Ming-Lun LI, Taoyuan City (TW); Meng-Yuan CHANG, Taichung City (TW); Wen-Chang CHEN, Taipei City (TW)

(21) Appl. No.: 19/221,528

(22) Filed: May 29, 2025

(30) Foreign Application Priority Data
May 31, 2024 (TW) 113120170

(51) Int. Cl. C07F 9/6574; C08G 65/48; C08K 5/5393

(52) U.S. Cl. CPC C07F 9/65744; C08G 65/485; C08K 5/5393

(57) ABSTRACT

A phosphorus-containing compound includes a structure represented by formula (I), and symbols in formula (I) are as defined in the specification. A manufacturing method of the phosphorus-containing compound includes performing a synthesis reaction, performing a catalytic reaction and performing a substitution reaction. The synthesis reaction is performed to react an organic phosphorus-containing compound with a carbonyl-containing compound so as to obtain a hydroxyl-containing compound. The catalytic reaction is performed to react the hydroxyl-containing compound with a phenol compound so as to obtain a phosphorus-based hydroxyl compound. The substitution reaction is performed so as to obtain the phosphorus-containing compound.

### RELATED APPLICATIONS

This application claims priority to Taiwan Application Serial Number 113120170, filed May 31, 2024, which is herein incorporated by reference.

### BACKGROUND

### Technical Field

The present disclosure relates to a phosphorus-containing compound, a manufacturing method of the phosphorus-containing compound, a flame-retardant polyphenylene oxide resin composition and a flame-retardant polyphenylene oxide resin cured product. More particularly, the present disclosure relates to a phosphorus-containing compound including phenyl methacrylate and vinylbenzylether functional group, a manufacturing method of the phosphorus-containing compound, a flame-retardant polyphenylene oxide resin composition and a flame-retardant polyphenylene oxide resin cured product.

### Description of Related Art

Polyphenylene oxide is often used as a insulation layer resin in high frequency communication substrate, and applied to printed circuit boards with flame retardants, rubber, glass fiber and copper foil laminated sheets, wherein the insulation layer resin and rubber are flammable materials, and flame retardants should be additionally added to improve the retardancy of the printed circuit boards.

In recent years, environmental awareness is being risen, flame retardants with halogen-containing have been gradually banned, and a trend is towards using halogen-free flame retardants. Common halogen-free flame retardants are phosphorus-based flame retardants, wherein a derivative of 9,10-dihydro-9-oxa-10-phosphaphenanthrene-10-oxide (DOPO) of the phosphorus-based flame retardant is more thermostable and chemical stable than the general organic phosphoric esters, and has the properties of high glass transition temperature and long-lasting flame retardancy.

However, there is a compatibility issue between general flame retardants and polyphenylene oxide resins, only some flame retardants can be uniformly dispersed in the polyphenylene oxide resins by processing, which results in problems of an uneven distribution or a flame retardant precipitation after a curing process, and is not favorable for applications.

For all these reasons, it is necessary to find a way to synthesize a phosphorus-containing compound compatible with polyphenylene oxide and with low manufacturing cost.

### SUMMARY

According to one aspect of the present disclosure, a phosphorus-containing compound includes a structure represented by formula (I):

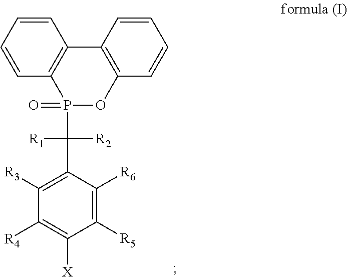

wherein R₁ and R₂ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a fluorenyl group or a halogen atom, R₃, R₄, R₅, and R₆ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a halogen atom or a nitro group, and X is a structure represented by formula (i), formula (ii), formula (iii) or formula (iv):

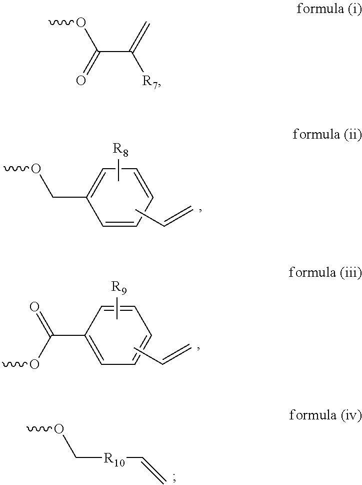

wherein R₇, R₈, and R₉ are each independently a hydrogen atom, an alkyl group of 1 to 6 carbon atoms, an unsubstituted phenyl group, a substituted phenyl group or a halogen atom, and R₁₀ is an alkylene group of 1 to 6 carbon atoms or an unsubstituted cycloalkylene group of 3 to 10 carbon atoms.

According to another aspect of the present disclosure, a manufacturing method of a phosphorus-containing compound includes performing a synthesis reaction, performing a catalytic reaction and performing a substitution reaction. In the synthesis reaction, an organic phosphorus-containing compound including a structure represented by formula (I) reacts with a carbonyl-containing compound including a structure represented by formula (2) so as to obtain a hydroxyl-containing compound including a structure represented by formula (3):

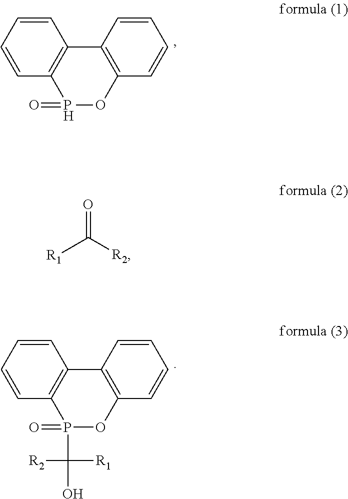

In the catalytic reaction, the hydroxyl-containing compound including the structure represented by formula (3) and a phenol compound including a structure represented by formula (4) are catalyzed with an acid catalyst so as to obtain a phosphorus-based hydroxyl compound including a structure represented by formula (5):

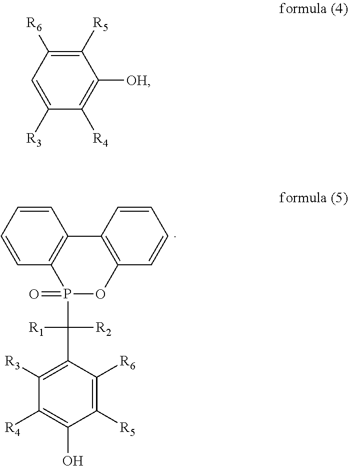

In the substitution reaction, the phosphorus-based hydroxyl compound including the structure represented by formula (5) reacts with a compound including a structure represented by formula (6), formula (7), formula (8) or formula (9) so as to obtain the phosphorus-containing compound:

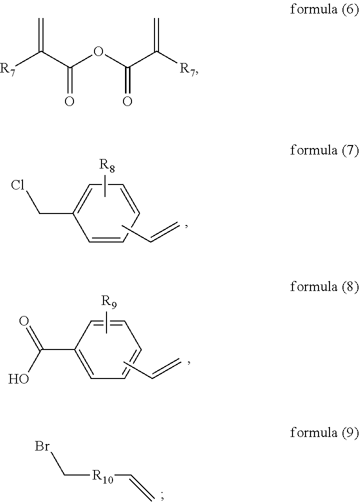

wherein R₁ and R₂ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a fluorenyl group or a halogen atom, R₃, R₄, R₅, and R₆ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a halogen atom or a nitro group;
wherein R₇, R₈, and R₉ are each independently a hydrogen atom, an alkyl group of 1 to 6 carbon atoms, an unsubstituted phenyl group, a substituted phenyl group or a halogen atom, and R₁₀ is an alkylene group of 1 to 6 carbon atoms or an unsubstituted cycloalkylene group of 3 to 10 carbon atoms.

According to still another aspect of the present disclosure, a manufacturing method of a phosphorus-containing compound includes performing a catalytic reaction and performing a substitution reaction. In the catalytic reaction, an organic phosphorus-containing compound including a structure represented by formula (I) and a bisphenol compound including a structure represented by formula (10) are catalyzed with an acid catalyst so as to obtain a phosphorus-based hydroxyl compound including a structure represented by formula (5):

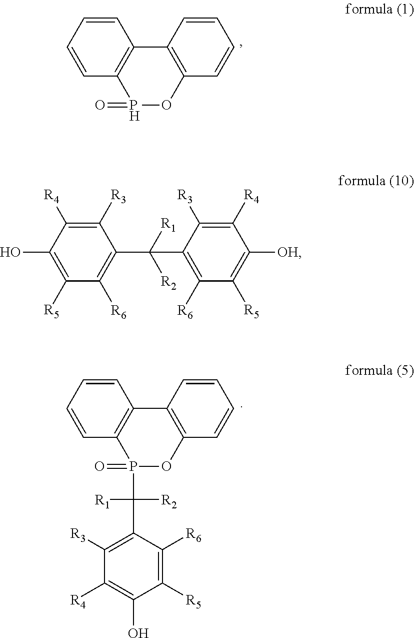

In the substitution reaction, the phosphorus-based hydroxyl compound including the structure represented by formula (5) reacts with a compound including a structure represented by formula (6), formula (7), formula (8) or formula (9) so as to obtain the phosphorus-containing compound:

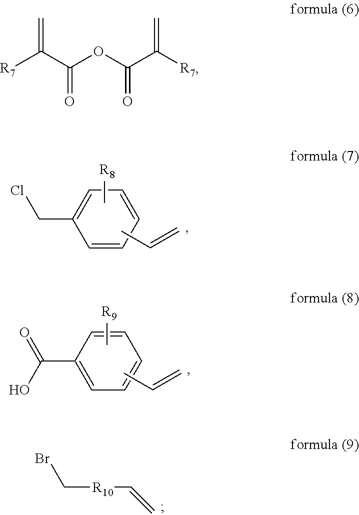

wherein R₁ and R₂ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a fluorenyl group or a halogen atom, R₃, R₄, R₅, and R₆ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a halogen atom or a nitro group;
wherein R₇, R₈, and R₉ are each independently a hydrogen atom, an alkyl group of 1 to 6 carbon atoms, an unsubstituted phenyl group, a substituted phenyl group or a halogen atom, and R₁₀ is an alkylene group of 1 to 6 carbon atoms or an unsubstituted cycloalkylene group of 3 to 10 carbon atoms.

According to yet another aspect of the present disclosure, a flame-retardant polyphenylene oxide resin composition is formed by mixing the aforementioned phosphorus-containing compound and a polyphenylene oxide resin.

According to still another aspect of the present disclosure, a flame-retardant polyphenylene oxide resin cured product is obtained by mixing and heating to cure any one of the aforementioned flame-retardant polyphenylene oxide resin composition and a double bond initiator.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a manufacturing method of a phosphorus-containing compound according to one embodiment of the present disclosure.

FIG. 2 is a flow chart of a manufacturing method of a phosphorus-containing compound according to another embodiment of the present disclosure.

FIG. 3 is a ¹H-NMR spectrum of Example 1.

FIG. 4 is a ¹H-NMR spectrum of Example 2.

FIG. 5 is a ¹H-NMR spectrum of Example 5.

FIG. 6 is a ¹H-NMR spectrum of Example 7.

### DETAILED DESCRIPTION

The present disclosure will be further exemplified by the following specific embodiments. However, the embodiments can be applied to various inventive concepts and can be embodied in various specific ways. The specific embodiments are only for the purposes of description, and are not limited to these practical details thereof. In addition, some conventional structures and elements are illustrated in the drawings in a simple and schematic way, and repeated elements can be presented by the same or similar reference numerals.

In the present disclosure, when a functional group is described with “Cₓ”, which means x carbon atoms of the functional group.

In the present disclosure, the compound structure can be represented by a skeleton formula, and the representation can omit the carbon atom, the hydrogen atom and the carbon-hydrogen bond. In the case that the functional group is depicted clearly in the structural formula, the depicted one is preferred.

In the present disclosure, in order to concise and smooth the description, “a phosphorus-containing compound includes a structure represented by formula (I)” can be represented as a phosphorus-containing compound represented by formula (I) or a phosphorus-containing compound (I) in some cases, and the other compounds or groups can be represented in the same manner.

### <Phosphorus-Containing Compound>

The present disclosure provides a phosphorus-containing compound, which includes a structure represented by formula (I):

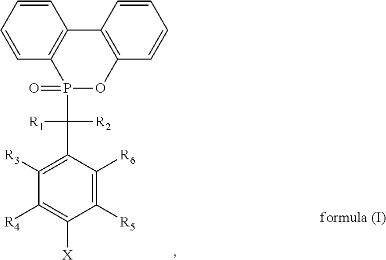

wherein R₁ and R₂ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a fluorenyl group or a halogen atom, R₃, R₄, R₅, and R₆ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a halogen atom or a nitro group, and X is a structure represented by formula (i), formula (ii), formula (iii) or formula (iv):

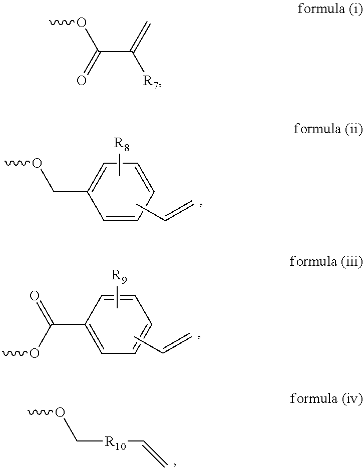

wherein R₇, R₈, and R₉ are each independently a hydrogen atom, an alkyl group of 1 to 6 carbon atoms, an unsubstituted phenyl group, a substituted phenyl group or a halogen atom, and R₁₀ is an alkylene group of 1 to 6 carbon atoms or an unsubstituted cycloalkylene group of 3 to 10 carbon atoms.

The aforementioned “substituted phenyl group” means that at least one hydrogen atom on a phenyl group can be replaced by a monovalent organic group or a halogen atom, the monovalent organic group can be an alkyl group of 1 to 6 carbon atoms or a trifluoromethyl group, and the halogen atom can be —F, —Cl or —Br.

The aforementioned “substituted cycloalkyl group” means that at least one hydrogen atom on a cycloalkyl group can be replaced by a monovalent organic group or a halogen atom, the monovalent organic group can be an alkyl group of 1 to 6 carbon atoms or a trifluoromethyl group, and the halogen atom can be —F, —Cl or —Br.

Therefore, the material cost of the phosphorus-containing compound of the present disclosure is low, and it is favorable for reducing the manufacturing cost so as to expand the scope of applications.

### <Manufacturing Method of Phosphorus-Containing Compound>

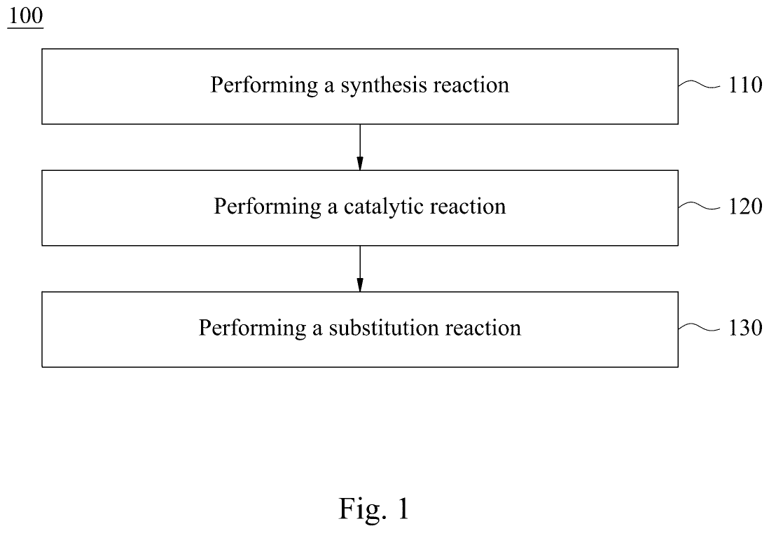

FIG. 1 is a flow chart of a manufacturing method of a phosphorus-containing compound 100 according to one embodiment of the present disclosure. In FIG. 1, the manufacturing method of the phosphorus-containing compound 100 includes step 110, step 120 and step 130.

In step 110, a synthesis reaction is performed, an organic phosphorus-containing compound including a structure represented by formula (I) reacts with a carbonyl-containing compound including a structure represented by formula (2) so as to obtain a hydroxyl-containing compound including a structure represented by formula (3):

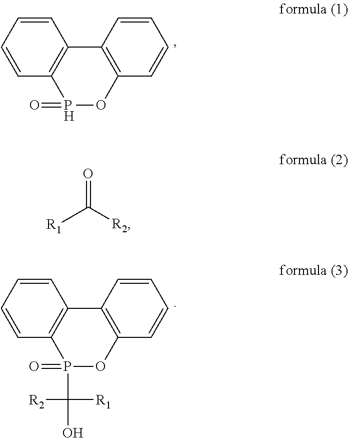

The reference of definitions of R₁ and R₂ is made to the aforementioned description, and will not describe again herein.

In step 120, a catalyst reaction is performed, the hydroxyl-containing compound including the structure represented by formula (3) and a phenol compound including a structure represented by formula (4) are catalyzed with an acid catalyst so as to obtain a phosphorus-based hydroxyl compound including a structure represented by formula (5):

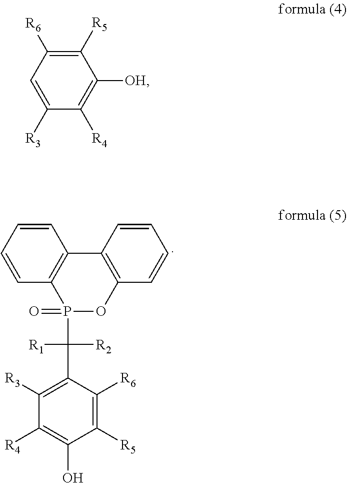

The reference of definitions of R₁, R₂, R₃, R₄, R₅ and R₆ is made to the aforementioned description, and will not describe again herein. The acid catalyst can be but not limited to acetic acid, methanesulfonic acid, oxalic acid, sulfuric acid, p-toluesulfonic acid or combinations thereof.

In step 130, a substitution reaction is performed, the phosphorus-based hydroxyl compound including the structure represented by formula (5) reacts with a compound including a structure represented by formula (6), formula (7), formula (8) or formula (9) so as to obtain the phosphorus-containing compound including a structure represented by formula (I):

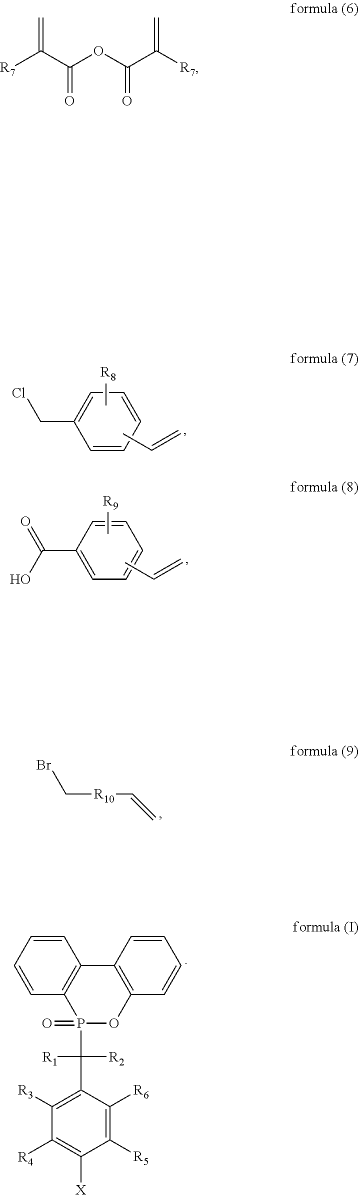

The reference of definitions of R₁, R₂, R₃, R₄, R₅, R₆, R₇, R₈, R₉, R₁₀ and X is made to the aforementioned description, and will not describe again herein.

Specifically, phosphorus-containing compounds are obtained by the phosphorus-based hydroxyl compound including the structure represented by formula (5) respectively reacting with compounds respectively including structures represented by formula (6), formula (7), formula (8) and formula (9), and the phosphorus-containing compounds respectively include structures represented by formula (I-1), formula (I-2), formula (I-3) and formula (I-4). The chemical reaction equations are shown in Table 1.

TABLE 1

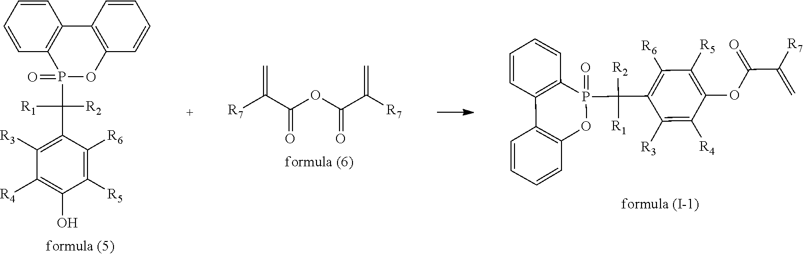

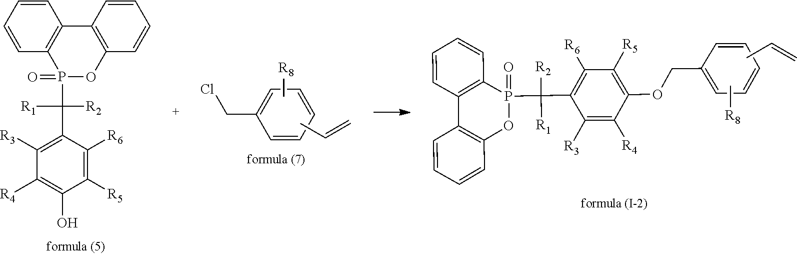

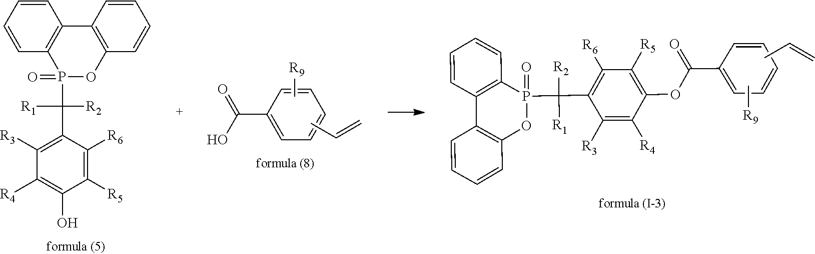

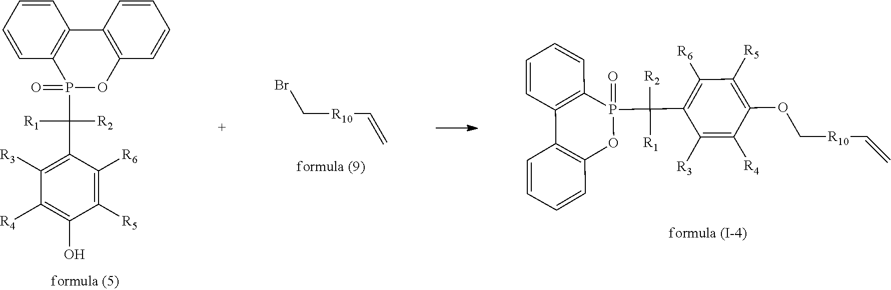

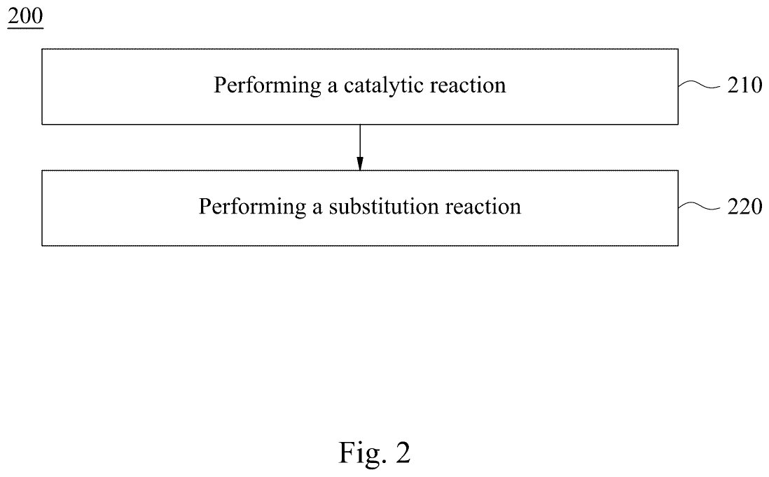

FIG. 2 is a flow chart of a manufacturing method of a phosphorus-containing compound 200 according to another embodiment of the present disclosure. The manufacturing method of a phosphorus-containing compound 200 includes step 210 and step 220.

In step 210, a catalytic reaction is performed, an organic phosphorus-containing compound including a structure represented by formula (I) and a bisphenol compound including a structure represented by formula (10) are catalyzed with an acid catalyst so as to obtain a phosphorus-based hydroxyl compound including a structure represented by formula (5):

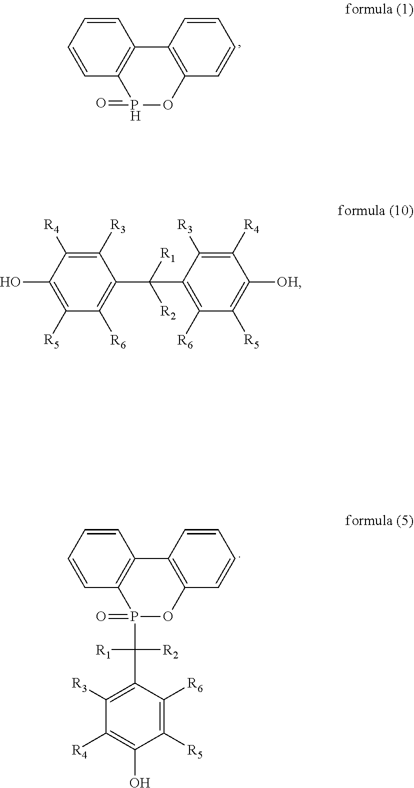

The reference of definitions of R₁, R₂, R₃, R₄, R₅ and R₆ and types of the acid catalyst is made to the aforementioned description, and will not describe again herein.

In step 220, a substitution reaction is performed, the phosphorus-based hydroxyl compound including the structure represented by formula (5) reacts with a compound including a structure represented by formula (6), formula (7), formula (8) or formula (9) so as to obtain the phosphorus-containing compound including a structure represented by formula (I):

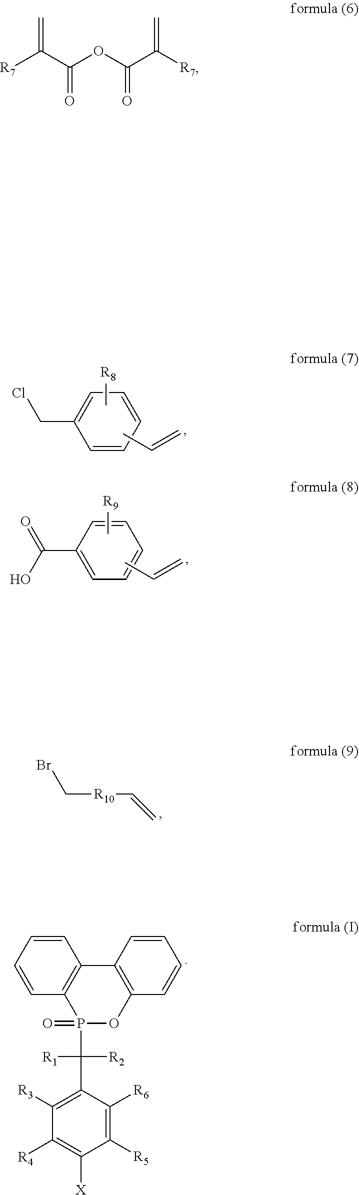

The reference of definitions of R₁, R₂, R₃, R₄, R₅, R₆, R₇, R₈, R₉, R₁₀ and X is made to the aforementioned description, and will not describe again herein.

### <Flame-Retardant Polyphenylene Oxide Resin Composition>

The present disclosure provides a flame-retardant polyphenylene oxide resin composition, which is formed by mixing the aforementioned phosphorus-containing compound and a polyphenylene oxide resin, and a phosphorus-content of the phosphorus-containing compound in the flame-retardant polyphenylene oxide resin composition can be 0.05% to 8%. The reference of the description of the phosphorus-containing compound is made to the above, and will not describe again herein.

### <Flame-Retardant Polyphenylene Oxide Resin Cured Product>

The present disclosure provides a flame-retardant polyphenylene oxide resin cured product, which is obtained by mixing the aforementioned flame-retardant polyphenylene oxide resin composition with a double bond initiator and heating to cure them. The double bond initiator can be but not limited to dicumyl peroxide, benzoylperoxide, tert-butylperoxyisopropyl benzene, di-tert-butyl peroxide or combinations thereof, and a content of the double bond initiator is 0.1 weight percent to 1.5 weight percent based on a total weight of the flame-retardant polyphenylene oxide resin composition.

In detail, the phosphorus-containing compound can be added into a polyphenylene oxide resin by physically mixing to give a flame retardant property to a final product, and the final product is the flame-retardant polyphenylene oxide resin cured product. The polyphenylene oxide resin refers to a polyphenylene oxide resin with double bonds, the double bonds of the polyphenylene oxide resin can react with terminal double bonds of the phosphorus-containing compound to polymerize via an addition reaction (hereinafter referred to as an addition polymerization), wherein the addition polymerization can be performed in a thermal curing condition, and the double bond initiator can be added according to actual requirements. Using the double bond initiator to open the double bonds in the polymerization is a conventional technology, and will not describe again herein.

The following specific embodiments further illustrate the present disclosure for those with ordinary skill in the technical field to utilize and realize the present disclosure without excessive interpretation. These embodiments should not limit the scope of the present disclosure, but illustrate how to implement the materials and methods of the present disclosure.

### Synthesis Example

Synthesis example 1: 10 g of DOPO monomer and 50 g of acetone were placed in a 250 ml three-necked reactor, stirred by a magnetic stirrer in a closed nitrogen atmosphere, and reacted at a reaction temperature of 50° C. for 6 hours. A white precipitate was filtered after the reaction so as to obtain a filter cake, a product could be obtained after drying the filter cake, a transparent crystal was obtained from the filtrate, and the yield rate was 98%. The chemical reaction according to Synthesis example 1 is shown in Table 2.

TABLE 2

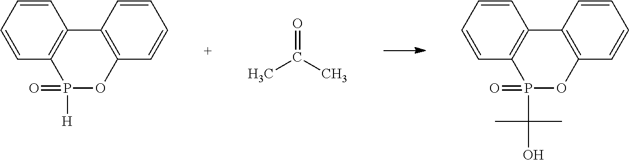

Synthesis example 2: 10 g of Synthesis example 1, 17.16 g of phenol and 0.4 g of p-toluenesulfonic acid were placed in a 250 ml three-necked reactor, stirred by a magnetic stirrer in a closed nitrogen atmosphere, and reacted at a reaction temperature of 110° C. for 6 hours. The three-necked reactor was cooled to the room temperature after the reaction, a content in the three-necked reactor was added into water and stirred so as to obtain a precipitate, the precipitate was washed several times with hot water, the precipitate was filtered and dried at 75° C. in a vacuum oven to obtain the white powder, and the yield rate was 81%. The chemical reaction according to Synthesis example 2 is shown in Table 3.

TABLE 3

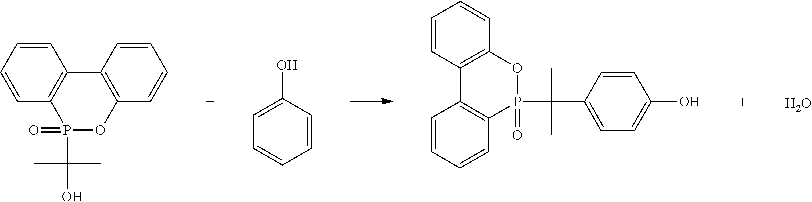 [SMILES: CC(C)(O)P1(=O)Oc2ccccc2-c2ccccc21 ; Oc1ccccc1 ; CC(C)(c1ccc(O)cc1)P1(=O)Oc2ccccc2-c2ccccc21 ; O]

Synthesis Example 3: 30 g of DOPO monomer, 15.8 g of bisphenol A and 1.2 g of p-toluenesulfonic acid were placed in a 100 ml three-necked reactor, stirred by a magnetic stirrer in a closed nitrogen atmosphere, and reacted at a reaction temperature of 130° C. for 12 hours. The three-necked reactor was cooled to the room temperature after the reaction, a content in the three-necked reactor was added into a solution of methanol/water (1/1, v/v) so as to obtain a precipitate, the precipitate was washed several times with the solution, the precipitate was filtered and dried at 75° C. in a vacuum oven to obtain the white powder, and the yield rate was 80%. The chemical reaction according to Synthesis example 3 is shown in Table 4.

TABLE 4

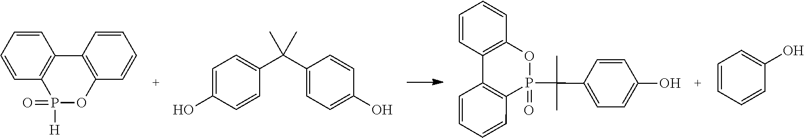 [SMILES: O=[PH]1Oc2ccccc2-c2ccccc21 ; CC(C)(c1ccc(O)cc1)c1ccc(O)cc1 ; CC(C)(c1ccc(O)cc1)P1(=O)Oc2ccccc2-c2ccccc21 ; Oc1ccccc1]

Synthesis example 4: 30 g of DOPO monomer, 19.74 g of tetramethyl bisphenol A and 1.2 g of p-toluenesulfonic acid were placed in a 100 ml three-necked reactor, stirred by a magnetic stirrer in a closed nitrogen atmosphere, and reacted at a reaction temperature of 140° C. for 12 hours. The three-necked reactor was cooled to the room temperature after the reaction, a content in the three-necked reactor was added into a solution of methanol/water (1/1, v/v) so as to obtain a precipitate, the precipitate was washed several times with the solution, the precipitate was filtered and dried at 75° C. in a vacuum oven to obtain the white powder, and the yield rate was 92%. The chemical reaction according to Synthesis example 4 is shown in Table 5.

TABLE 5

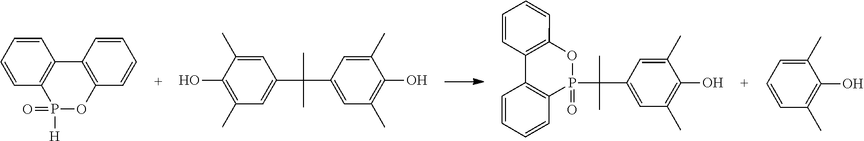

Synthesis example 5: 30 g of monomer, 24.31 g of 4,4′-(9-Fluorenylidene) diphenol and 1.2 g of p-toluenesulfonic acid were placed in a 100 ml three-necked reactor, stirred by a magnetic stirrer in a closed nitrogen atmosphere, and reacted at a reaction temperature of 140° C. for 12 hours. The three-necked reactor was cooled to the room temperature after the reaction, a content in the three-necked reactor was added into a solution of methanol/water (1/1, v/v) so as to obtain a precipitate, the precipitate was washed several times with the solution, the precipitate was filtered and dried at 75° C. in a vacuum oven to obtain the white powder, and the yield rate was 90%. The chemical reaction according to Synthesis example 5 is shown in Table 6.

TABLE 6

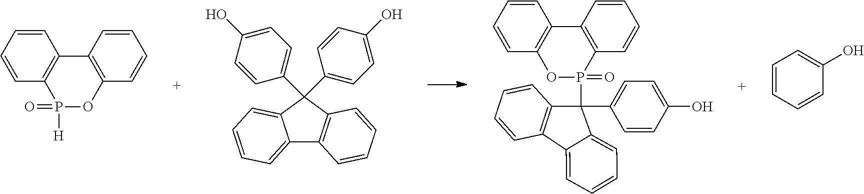 [SMILES: O=[PH]1Oc2ccccc2-c2ccccc21 ; Oc1ccc(C2(c3ccc(O)cc3)c3ccccc3-c3ccccc32)cc1 ; O=P1(C2(c3ccc(O)cc3)c3ccccc3-c3ccccc32)Oc2ccccc2-c2ccccc21 ; Oc1ccccc1]

Synthesis example 6: 30 g of DOPO monomer, 18.62 g of bisphenol Z and 1.2 g of p-toluenesulfonic acid were placed in a 100 ml three-necked reactor, stirred by a magnetic stirrer in a closed nitrogen atmosphere, and reacted at a reaction temperature of 130° C. for 12 hours. The three-necked reactor was cooled to the room temperature after the reaction, a content in the three-necked reactor was added into a solution of methanol/water (1/1, v/v) so as to obtain a precipitate, the precipitate was washed several times with the solution, the precipitate was filtered and dried at 75° C. in a vacuum oven to obtain the white powder, and the yield rate was 80%. The chemical reaction according to Synthesis example 6 is shown in Table 7.

TABLE 7

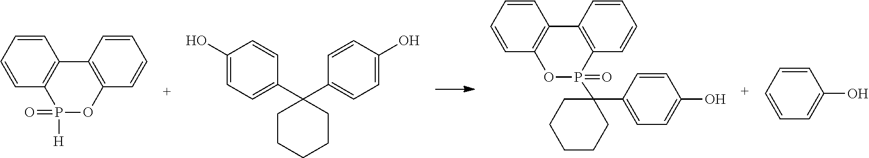 [SMILES: O=[PH]1Oc2ccccc2-c2ccccc21 ; Oc1ccc(C2(c3ccc(O)cc3)CCCCC2)cc1 ; O=P1(C2(c3ccc(O)cc3)CCCCC2)Oc2ccccc2-c2ccccc21 ; Oc1ccccc1]

### Example

Example 1: 10 g of Synthesis example 2 or Synthesis example 3, 13.2 g of methacrylic anhydride, 0.264 g of sodium acetate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 1 is shown in Table 8.

TABLE 8

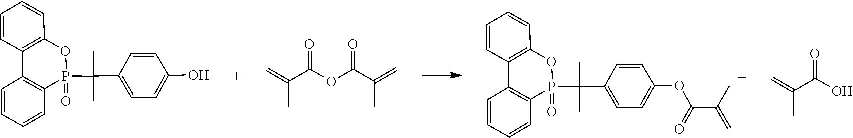

Example 2: 10 g of Synthesis example 2 or Synthesis example 3, 5.21 g of 4-chlorostyrene, 0.072 g of potassium carbonate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 2 is shown in Table 9.

TABLE 9

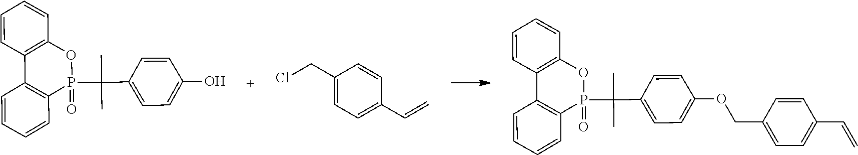

Example 3: 10 g of Synthesis example 4, 6.111 g of methacrylic anhydride, 0.12 g of sodium acetate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 3 is shown in Table 10.

TABLE 10

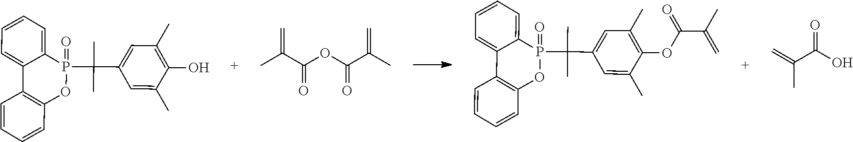

Example 4: 10 g of Synthesis example 4, 5.63 g of 4-chlorostyrene, 0.078 g of potassium carbonate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 4 is shown in Table 11.

TABLE 11

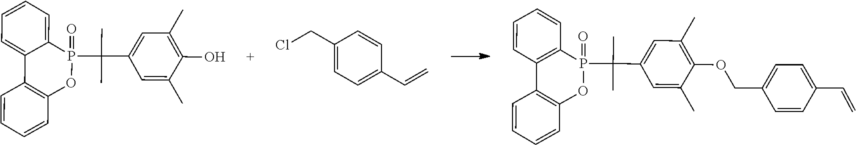

Example 5: 10 g of Synthesis example 5, 4.89 g of methacrylic anhydride, 0.098 g of sodium acetate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 5 is shown in Table 12.

TABLE 12

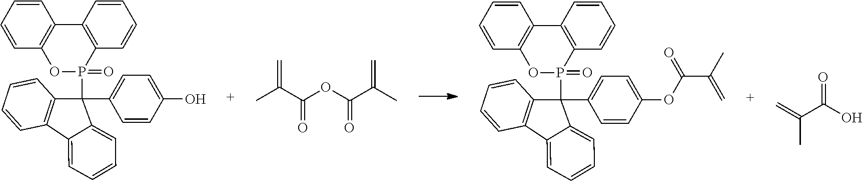

Example 6: 10 g of Synthesis example 5, 7.03 g of 4-chlorostyrene, 0.097 g of potassium carbonate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 6 is shown in Table 13.

TABLE 13

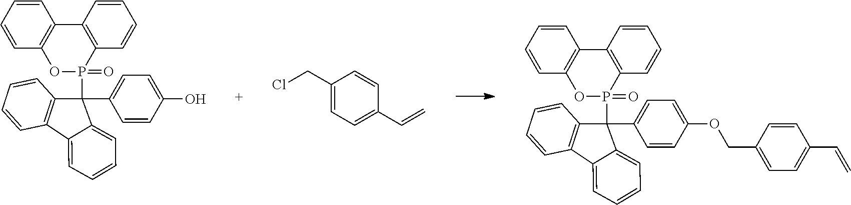

Example 7: 10 g of Synthesis example 6, 5.92 g of methacrylic anhydride, 0.118 g of sodium acetate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 7 is shown in Table 14.

TABLE 14

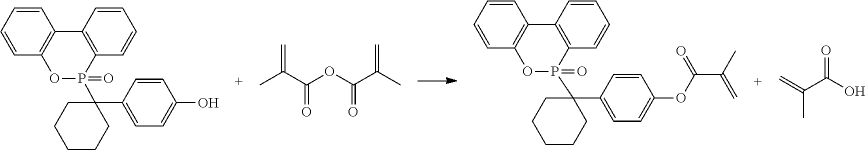

Example 8: 10 g of Synthesis example 6, 7.03 g of 4-chlorostyrene, 0.097 g of potassium carbonate and 30 ml of dimethyl acetamide were placed in a 100 ml three-necked reactor, stirred by a magnetic stirrer in a closed nitrogen atmosphere, and reacted at a reaction temperature of 80° C. for 24 hours. The three-necked reactor was cooled to the room temperature after the reaction, a content in the three-necked reactor was added into deionized water so as to obtain a precipitate, the precipitate was washed several times with deionized water, the precipitate was filtered and dried at 75° C. in a vacuum oven to obtain the white powder, and the yield rate was 80%. The chemical reaction according to Example 8 is shown in Table 15.

TABLE 15

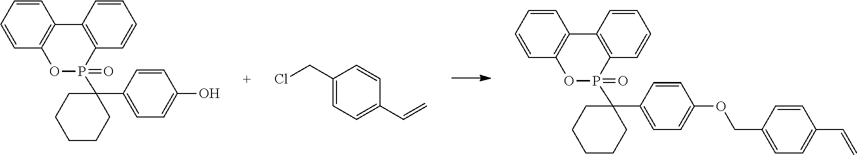

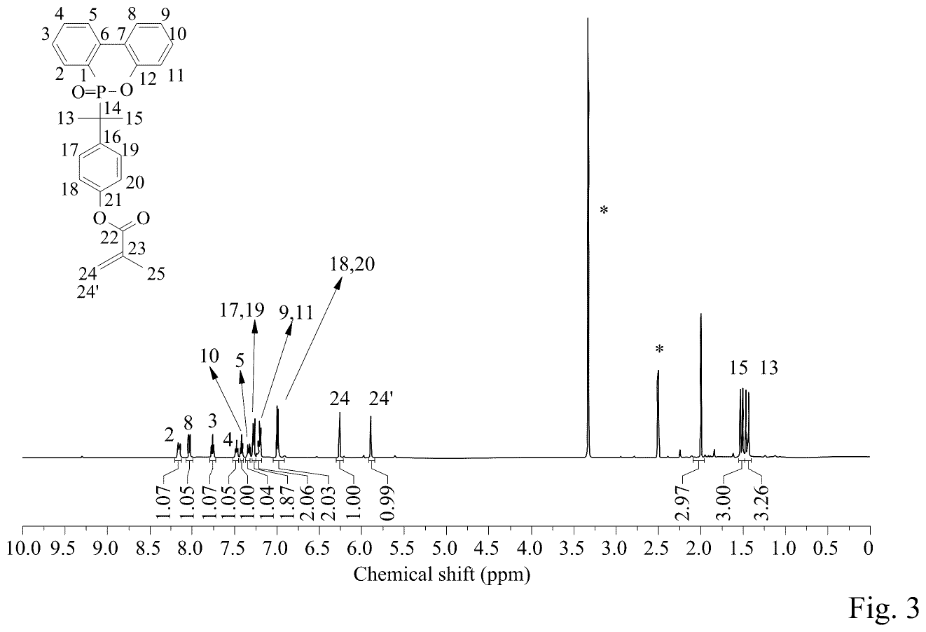

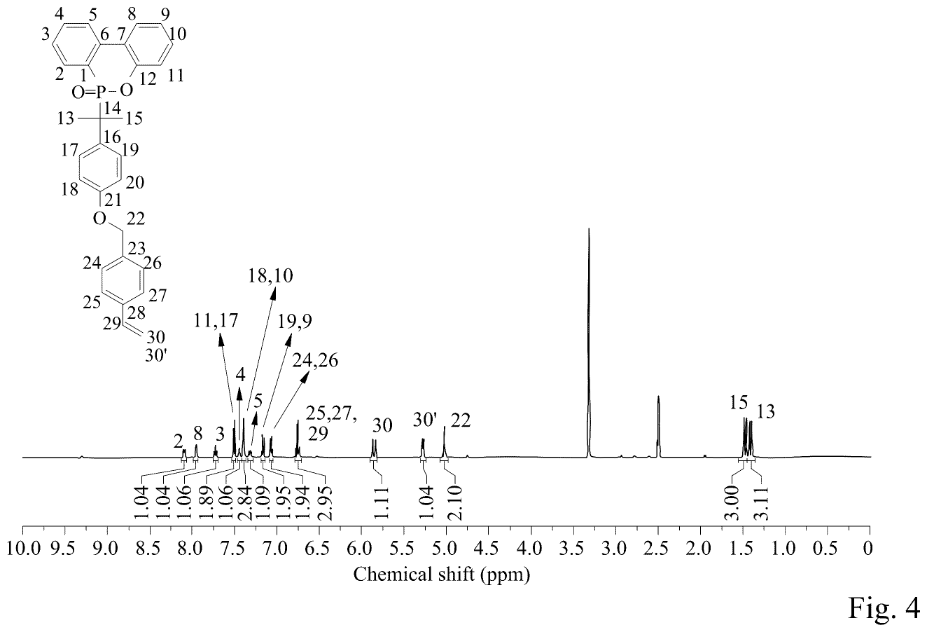

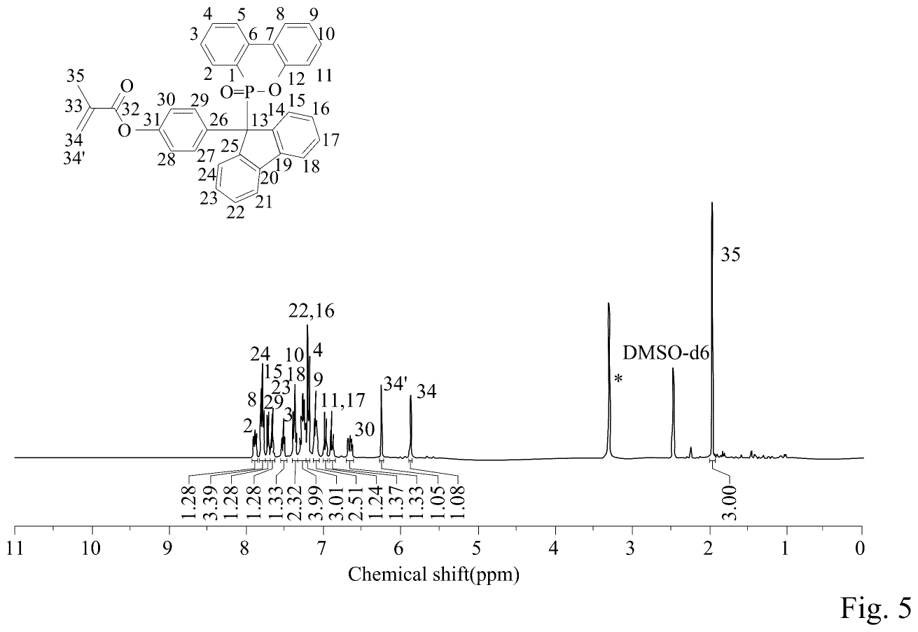

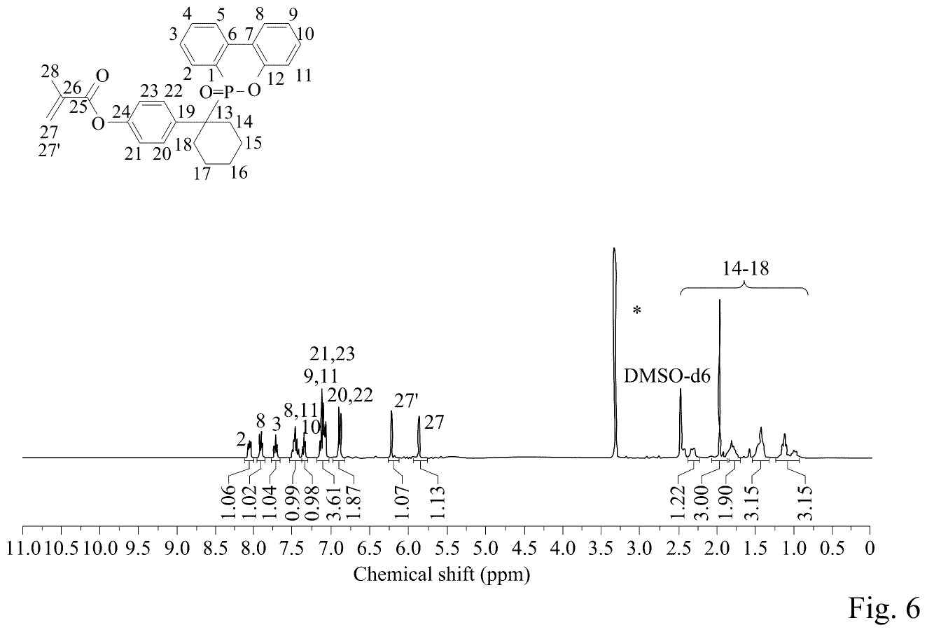

The ¹H-NMR analysis of Example 1, Example 2, Example 5 an Example 7 was performed to confirm the structures of the phosphorus-containing compound of the present disclosure. Reference is made to FIG. 3, FIG. 4, FIG. 5 and FIG. 6, FIG. 3 is a ¹H-NMR spectrum of Example 1, FIG. 4 is a ¹H-NMR spectrum of Example 2, FIG. 5 is a ¹H-NMR spectrum of Example 5, and FIG. 6 is a ¹H-NMR spectrum of Example 7. According to the results in FIG. 3 to FIG. 6, it is confirmed that the phosphorus-containing compounds of Example 1, Example 2, Example 5 and Example 7 were successfully synthesized in the present disclosure.

### <Flame-Retardant Polyphenylene Oxide Resin Composition>

Flame-retardant polyphenylene oxide resin compositions of Example 9 to Example 20 were respectively formed by respectively mixing Example 1 and Example 2 and a commercialized polyphenylene oxide resin, wherein the commercialized polyphenylene oxide resin was selected from SA9000 from SABIC and OPE-2st from MITSUBISHI CHEMICAL. Specifically, Example 1 and Example 2 with different phosphorus-contents were mixed with the commercialized polyphenylene oxide resin, and then a double bond initiator was added, wherein a content of the double bond initiator is 0.1 weight percent based on a total weight of the flame-retardant polyphenylene oxide resin composition, and finally a solution with 20% of solid content was prepared with xylene. Moreover, Comparative example 1 and Comparative example 2 were respectively composed of the commercialized polyphenylene oxide resin, and the preparation method is the same as the preparation methods of Example 9 to Example 20. Conditions of the flame-retardant polyphenylene oxide resin compositions according to Example 9 to Example 20, Comparative example 1 and Comparative example 2 are listed in Table 16.

TABLE 16

| | Phosphorus- | | Phosphorus- |
|---|---|---|---|
| | containing | Polyphenylene | content |
| | compound | oxide resin | (%) |
| Example 9 | Example 1 | SA 9000 | 0.3 |
| Example 10 | Example 1 | | 0.6 |
| Example 11 | Example 1 | | 0.9 |
| Example 12 | Example 2 | | 0.3 |
| Example 13 | Example 2 | | 0.6 |
| Example 14 | Example 2 | | 0.9 |
| Example 15 | Example 1 | OPE-2st | 0.3 |
| Example 16 | Example 1 | | 0.6 |
| Example 17 | Example 1 | | 0.9 |
| Example 18 | Example 2 | | 0.3 |
| Example 19 | Example 2 | | 0.6 |
| Example 20 | Example 2 | | 0.9 |
| Comparative | — | SA 9000 | 0 |
| example 1 | | | |
| Comparative | — | OPE-2st | 0 |
| example 2 | | | |

### <Flame-Retardant Polyphenylene Oxide Resin Cured Product>

Flame-retardant polyphenylene oxide resin cured products of Example 21 to Example 32, Comparative example 3 and Comparative example 4 were respectively obtained by respectively and uniformly mixing the flame-retardant polyphenylene oxide resin compositions of Example 9 to Example 20, Comparative example 1 and Comparative example 2, the flame-retardant polyphenylene oxide resin compositions were respectively poured in molds, and heated to cure under a nitrogen atmosphere. Heating conditions are 60° C. (4 hours), 80° C. (4 hours), 120° C. (2 hours), 180° C. (2 hours), 200° C. (2 hours) and 220° C. (2 hours). Therefore, flame-retardant polyphenylene oxide resin cured products of Example 21 to Example 32, Comparative example 3 and Comparative example 4 were obtained after a demolding process.

### <Thermal Property Evaluation>

Thermal property evaluation of Example 21 to Example 32, Comparative example 3 and Comparative example 4 were performed by the methods below.

(1) The storage modulus, the relationship between the Tan delta curve and the temperature and the glass transition temperature (T_{g}) of the flame-retardant polyphenylene oxide resin cured products were measured by a dynamic mechanical analyzer (DMA), wherein the heating rate is 5° C./min, and the temperature range is 40° C. to 350° C.

(2) The glass transition temperature and the coefficient of thermal expansion (CPE) of the flame-retardant polyphenylene oxide resin cured products were measured by the thermomechanical analysis (TMA), wherein the heating rate is 5° C./min, and the temperature range is 50° C. to 150° C.

(3) The 5% weight loss temperature (T_{d5%}) and the char yield at 800° C. of the flame-retardant polyphenylene oxide resin cured products were measured by the thermogravimetry analysis (TGA). The measurement condition is 20° C./min of heating rate under a nitrogen atmosphere, and the weight change of the sample is measured by a thermogravimetry analyzer. The 5% weight loss temperature means the temperature at that a weight loss of a sample achieves 5%, wherein when the 5% weight loss temperature is higher, the thermal stability of the sample is better. The char yield at 800° C. means the char yield of a sample at 800° C., wherein when the char yield is higher, the thermal stability of the sample is better.

The thermal property evaluation of Example 21 to Example 32, Comparative example 3 and Comparative example 4 are listed in Table 17.

TABLE 17

| | T_{g} (° C.) | T_{g} (° C.) | CTE | T_{d5%} | Char yield |
|---|---|---|---|---|---|
| | (DMA) | (TMA) | (ppm/° C.) | (° C.) | (%) |
| Example 21 | 234 | 210 | 62 | 454 | 21 |
| Example 22 | 232 | 199 | 63 | 433 | 21 |
| Example 23 | 224 | 198 | 68 | 403 | 22 |
| Example 24 | 243 | 206 | 69 | 455 | 23 |
| Example 25 | 234 | 186 | 67 | 438 | 22 |
| Example 26 | 229 | 176 | 69 | 418 | 22 |
| Example 27 | 225 | 193 | 53 | 353 | 31 |
| Example 28 | 221 | 182 | 64 | 386 | 31 |
| Example 29 | 216 | 179 | 63 | 422 | 32 |
| Example 30 | 220 | 189 | 50 | 352 | 33 |
| Example 31 | 215 | 179 | 61 | 384 | 33 |
| Example 32 | 212 | 174 | 61 | 427 | 33 |
| Comparative | 228 | 201 | 63 | 457 | 20 |
| example 3 | | | | | |
| Comparative | 229 | 199 | 76 | 394 | 27 |
| example 4 | | | | | |

In Table 17, according to the results of the glass transition temperature measured by DMA, the glass transition temperatures of Example 21 to Example 32 are good, and similar to the glass transition temperatures of Comparative example 3 and Comparative example 4. Moreover, according to the results of the thermostability measured by TGA, the 5% weight loss temperatures of Example 21 to Example 32 are higher than 350° C. Therefore, the thermal property evaluation shows that adding the phosphorus-containing compound of the present disclosure into the polyphenylene oxide resins will not influence the thermal property of the flame-retardant polyphenylene oxide resin cured products, and the flame-retardant polyphenylene oxide resin cured products of the present disclosure are thermostable.

### <Flame Retardancy Evaluation>

UL-94 flame retardancy evaluation of Example 21 to Example 32, Comparative example 3 and Comparative example 4 is performed, and the steps are as below. A film of 8 in.×2 in. was wrapped on a cylindrical support with a diameter of 0.5 in., the cylindrical support was moved so that 5 in. of the film was wrapped around the cylindrical support, and the film not on the cylindrical support was stretched to form a cone, and then the sample preparation was finished. The prepared sample was burned with a flame for 3 seconds, and then the flame was removed and a burning time was recorded as t₁. Then, after the prepared sample was cooled, the prepared sample was burned with the flame for 3 seconds again, and the flame was removed and a burning time was recorded as t₂. During the aforementioned burning process, cotton was placed 12 in. below the prepared sample so as to observe the dripping. Afterwards, the above steps were repeated for the rest samples, and t₁ and t₂ were recorded. When the average of t₁ and t₂ is between 10 seconds to 30 seconds, a sum of t₁ and t₂ is not greater than 50 seconds, no dripping is observed, and the prepared sample is UL-94 VTM-0 grade. When the average of t₁ and t₂ is between 10 seconds to 30 seconds, no dripping is observed, and the prepared sample is UL-94 VTM-1 grade.

Results of the flame retardancy evaluation of Example 21 to Example 32, Comparative example 3 and Comparative example 4 are listed in Table 18.

TABLE 18

| | t₁ (second) | t₂ (second) | dripping | grade |
|---|---|---|---|---|
| Example 21 | 1.38 | 1.56 | No | VTM-0 |
| Example 22 | 0.60 | 0.30 | No | VTM-0 |
| Example 23 | 0.35 | 0.30 | No | VTM-0 |
| Example 24 | 2.92 | 0.30 | No | VTM-0 |
| Example 25 | 0.94 | 0.30 | No | VTM-0 |
| Example 26 | 0.40 | 0.30 | No | VTM-0 |
| Example 27 | 2.08 | 0.18 | No | VTM-0 |
| Example 28 | 1.35 | 0.22 | No | VTM-0 |
| Example 29 | 0.76 | 0.10 | No | VTM-0 |
| Example 30 | 2.01 | 0.20 | No | VTM-0 |
| Example 31 | 1.42 | 0.26 | No | VTM-0 |
| Example 32 | 0.83 | 0.10 | No | VTM-0 |
| Comparative | 1.38 | 1.98 | No | VTM-0 |
| example 3 | | | | |
| Comparative | 3.30 | 2.00 | Yes | VTM-1 |
| example 4 | | | | |

In Table 18, according to the results of the UL-94 flame retardancy evaluation, the burning times of Example 21 to Example 32 added the phosphorus-containing compound are obviously less than Comparative example 3 and Comparative example 4, it proves that adding the phosphorus-containing compound of the present disclosure is beneficial to the flame retardancy of the flame-retardant polyphenylene oxide resin cured products, and Example 21 to Example 32 are all VTM-0 grade.

### <Electrical Property Evaluation>

The electrical property evaluation of Example 21 to Example 32, Comparative example 3 and Comparative example 4 was performed by a dielectric constant analysis at 10 GHz to measure the dielectric constant and the dielectric loss of the cured films, wherein the cured films were cut into 9 cm×13 cm. Results of the electrical property evaluation of Example 21 to Example 32, Comparative example 3 and Comparative example 4 are listed in Table 19.

TABLE 19

| | Dielectric constant | Dielectric loss |
|---|---|---|
| Example 21 | 2.50 | 3.68 |
| Example 22 | 2.51 | 3.86 |
| Example 23 | 2.60 | 3.75 |
| Example 24 | 2.43 | 2.90 |
| Example 25 | 2.52 | 3.40 |
| Example 26 | 2.47 | 3.90 |
| Example 27 | 2.61 | 3.64 |
| Example 28 | 2.66 | 3.73 |
| Example 29 | 2.83 | 4.37 |
| Example 30 | 2.58 | 3.77 |
| Example 31 | 2.72 | 3.84 |
| Example 32 | 2.90 | 4.54 |
| Comparative example 3 | 2.47 | 3.56 |
| Comparative example 4 | 2.56 | 7.30 |

In Table 19, the flame-retardant polyphenylene oxide resin cured products of Example 21 to Example 32 were added the phosphorus-containing compound with specific phosphorus-contents so as to retain an appropriate electrical property.

In conclusion, the phosphorus-containing compound of the present disclosure can be manufactured with a low cost so as to reduce the manufacturing cost, and the phosphorus-containing compound is well compatible with polyphenylene oxide resins so that the flame-retardant polyphenylene oxide resin cured products with a high glass transition temperature, a low dielectric property, a thermo-stability and a good flame retardancy is obtained, and the flame-retardant polyphenylene oxide resin cured products can be used as the material of base boards, copper foil substrates or printed circuit boards.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A phosphorus-containing compound, comprising a structure represented by formula (I): 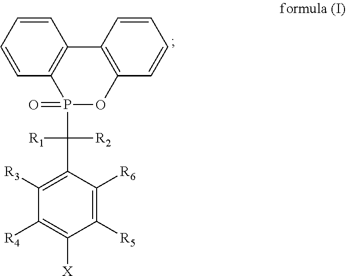
wherein R₁ and R₂ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a fluorenyl group or a halogen atom; R₃, R₄, R₅, and R₆ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a halogen atom or a nitro group, and X is a structure represented by formula (i), formula (ii), formula (iii) or formula (iv): 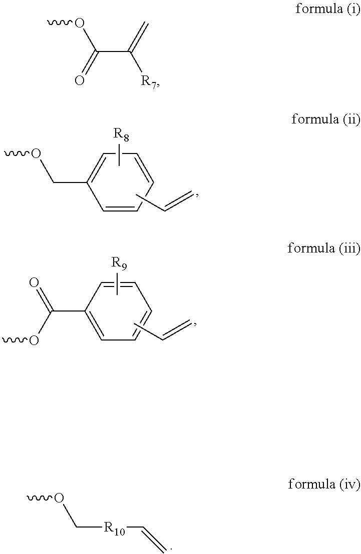
wherein R₇, R₈, and R₉ are each independently a hydrogen atom, an alkyl group of 1 to 6 carbon atoms, an unsubstituted phenyl group, a substituted phenyl group or a halogen atom, and R₁₀ is an alkylene group of 1 to 6 carbon atoms or an unsubstituted cycloalkylene group of 3 to 10 carbon atoms.

2. A manufacturing method of a phosphorus-containing compound, comprising:
performing a synthesis reaction to react an organic phosphorus-containing compound comprising a structure represented by formula (1) with a carbonyl-containing compound comprising a structure represented by formula (2) so as to obtain a hydroxyl-containing compound comprising a structure represented by formula (3): 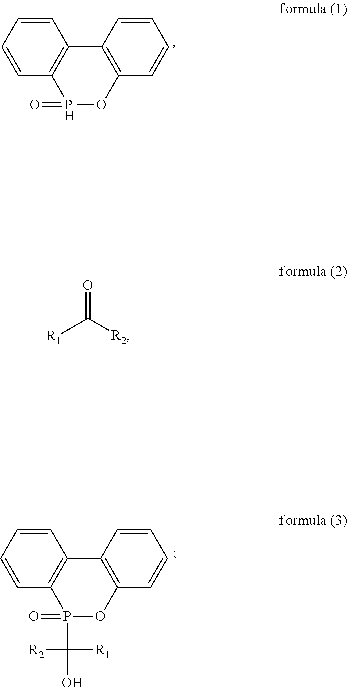
performing a catalytic reaction to react the hydroxyl-containing compound comprising the structure represented by formula (3) with a phenol compound comprising a structure represented by formula (4) catalyzed with an acid catalyst so as to obtain a phosphorus-based hydroxyl compound comprising a structure represented by formula (5): 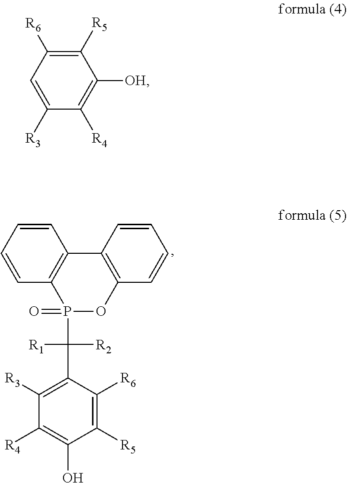
performing a substitution reaction to react the phosphorus-based hydroxyl compound comprising the structure represented by formula (5) with a compound comprising a structure represented by formula (6), formula (7), formula (8) or formula (9) so as to obtain the phosphorus-containing compound: 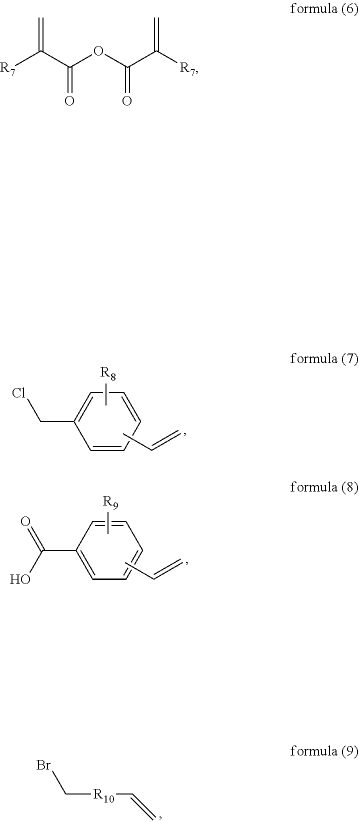
wherein R₁ and R₂ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a fluorenyl group or a halogen atom, R₃, R₄, R₅, and R₆ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a halogen atom or a nitro group;
wherein R₇, R₈, and R₉ are each independently a hydrogen atom, an alkyl group of 1 to 6 carbon atoms, an unsubstituted phenyl group, a substituted phenyl group or a halogen atom, and R₁₀ is an alkylene group of 1 to 6 carbon atoms or an unsubstituted cycloalkylene group of 3 to 10 carbon atoms.

3. The manufacturing method of the phosphorus-containing compound of claim 2, wherein the phosphorus-containing compound comprises a structure represented by formula (I): 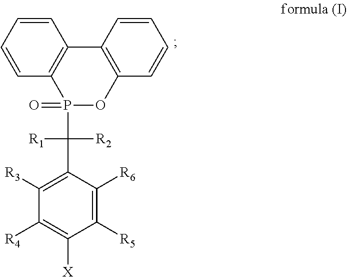
wherein X is a structure represented by formula (i), formula (ii), formula (iii) or formula (iv):

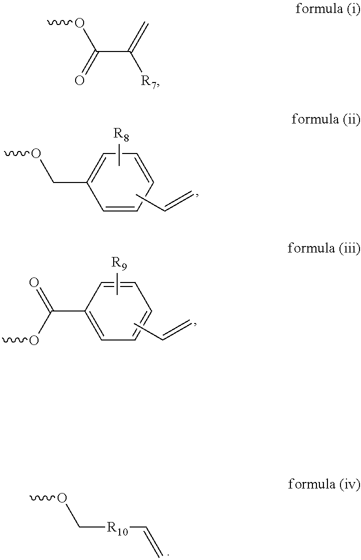

4. The manufacturing method of the phosphorus-containing compound of claim 2, wherein the acid catalyst is acetic acid, methanesulfonic acid, oxalic acid, sulfuric acid, p-toluenesulfonic acid or a mixture thereof.

5. A manufacturing method of a phosphorus-containing compound, comprising:
performing a catalytic reaction to react an organic phosphorus-containing compound comprising a structure represented by formula (1) with a bisphenol compound comprising a structure represented by formula (10) catalyzed with an acid catalyst so as to obtain a phosphorus-based hydroxyl compound comprising a structure represented by formula (5): 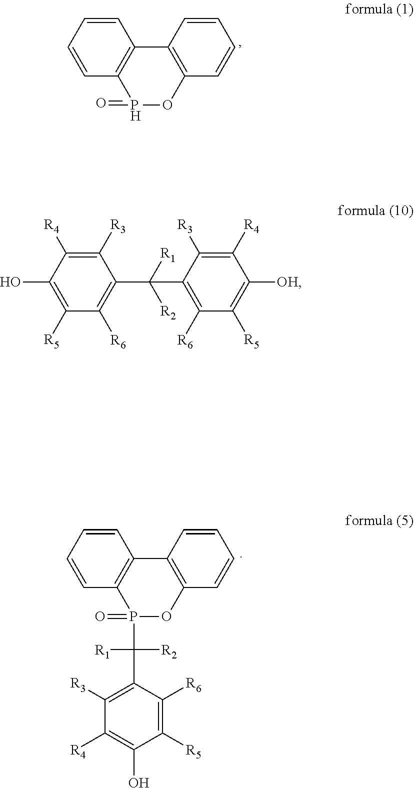
performing a substitution reaction to react the phosphorus-based hydroxyl compound comprising the structure represented by formula (5) with a compound comprising a structure represented by formula (6), formula (7), formula (8) or formula (9) so as to obtain the phosphorus-containing compound: 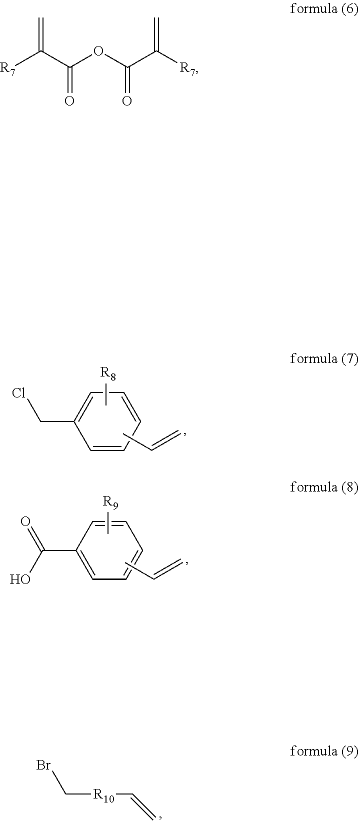
wherein R₁ and R₂ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a fluorenyl group or a halogen atom, R₃, R₄, R₅, and R₆ are each independently a hydrogen atom, an alkyl group of 1 to 6 carbon atoms, a trifluoromethyl group, an unsubstituted phenyl group, a substituted phenyl group, an unsubstituted cycloalkyl group of 3 to 10 carbon atoms, a substituted cycloalkyl group of 3 to 10 carbon atoms, a halogen atom or a nitro group;
wherein R₇, R₈, and R₉ are each independently a hydrogen atom, an alkyl group of 1 to 6 carbon atoms, an unsubstituted phenyl group, a substituted phenyl group or a halogen atom, and R₁₀ is an alkylene group of 1 to 6 carbon atoms or an unsubstituted cycloalkylene group of 3 to 10 carbon atoms.

6. The manufacturing method of the phosphorus-containing compound of claim 5, wherein the phosphorus-containing compound comprises a structure represented by formula (I): 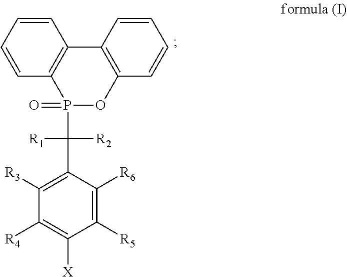
wherein X is a structure represented by formula (i), formula (ii), formula (iii) or formula (iv):

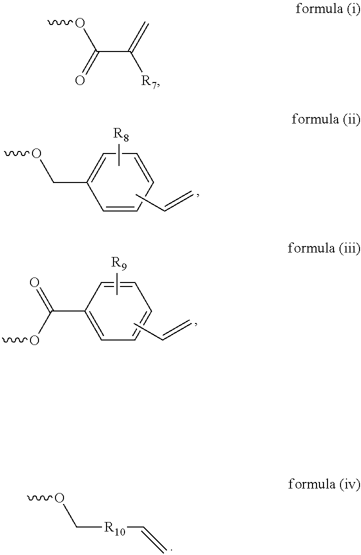

7. The manufacturing method of the phosphorus-containing compound of claim 5, wherein the acid catalyst is acetic acid, methanesulfonic acid, oxalic acid, sulfuric acid, p-toluenesulfonic acid or a mixture thereof.

8. A flame-retardant polyphenylene oxide resin composition, which is formed by mixing the phosphorus-containing compound of claim 1 and a polyphenylene oxide resin.

9. The flame-retardant polyphenylene oxide resin composition of claim 8, wherein a phosphorus-content of the phosphorus-containing compound in the flame-retardant polyphenylene oxide resin composition is 0.05% to 8%.

10. A flame-retardant polyphenylene oxide resin cured product, which is obtained by mixing and heating to cure the flame-retardant polyphenylene oxide resin composition of claim 8 and a double bond initiator.

11. A flame-retardant polyphenylene oxide resin cured product, which is obtained by mixing and heating to cure the flame-retardant polyphenylene oxide resin composition of claim 9 and a double bond initiator.

12. The flame-retardant polyphenylene oxide resin cured product of claim 10, wherein the double bond initiator is dicumyl peroxide, benzoyl peroxide, di(tert-butylperoxyisopropyl) benzene, di-tert-butyl peroxide or a mixture thereof.

13. The flame-retardant polyphenylene oxide resin cured product of claim 10, wherein a content of the double bond initiator is 0.1 weight percent to 1.5 weight percent based on a total weight of the flame-retardant polyphenylene oxide resin composition.
